(19) United States
(12) Patent Application Publication
(10) Pub. No.: US 2018/0059446 A1
(43) Pub. Date: Mar. 1, 2018

(54) OPTICAL ISO-MODULATOR

(71) Applicants: Woosung Kim, Mountain View, CA (US); John Heck, Berkeley, CA (US); Haisheng Rong, Pleasanton, CA (US); Jeffrey B. Driscoll, San Jose, CA (US); Kimchau N. Nguyen, Los Gatos, CA (US)

(72) Inventors: Woosung Kim, Mountain View, CA (US); John Heck, Berkeley, CA (US); Haisheng Rong, Pleasanton, CA (US); Jeffrey B. Driscoll, San Jose, CA (US); Kimchau N. Nguyen, Los Gatos, CA (US)

(21) Appl. No.: 15/250,745

(22) Filed: Aug. 29, 2016

(51) Int. Cl. G02F 1/095; G02B 6/12; G02F 1/09; G02F 1/00

(52) U.S. Cl. CPC G02F 1/0955; G02F 1/0036; G02F 1/092; G02B 6/12004

(57) ABSTRACT

Apparatuses, methods and storage medium associated with an optical iso-modulator are disclosed herein. In embodiments, an apparatus may include an optical waveguide formed on one or more layers, such as an isolation layer and a handling layer. A modulator driver may be coupled to a first side of the one or more layers. A magneto-optical (MO) die may be coupled to a second side of the one or more layers that is opposite the first side. Other embodiments may be disclosed and/or claimed.

### TECHNICAL FIELD

Embodiments of the present disclosure generally relate to the field of optoelectronics and, more particularly, to photonic integrated circuits with optical iso-modulators.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Photonic integrated circuits may be considered a promising candidate for next generation interconnects for data center and high performance computing. Optical waveguide-based photonics integrated circuits such as lasers, modulators, and detectors may be typically fabricated on silicon-on-insulator (SOI) wafers. At a high data rate, e.g., larger than 10 Gb/s, a minor laser instability may cause burst bit errors and may disrupt the operations on a link of the interconnects significantly. Laser instability may be caused by feedback or reflections to the laser.

An optical isolator may be used for protecting photonics integrated circuits from reflections because an optical isolator may allow light waves to propagate in specified directions while preventing the propagation of light waves in undesired directions. However, a traditional optical isolator may be a standalone device, which may be bulky, expensive, and complicated to integrate. In addition, many existing optical isolators may have high insertion loss and complicated manufacturing processes. High insertion loss may be a challenging barrier to the commercialization of optical isolators, while complicated manufacturing processes for optical isolators may be costly and hard to manage.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 is a block diagram of an optoelectronic system incorporated with a photonic integrated circuit having an iso-modulator, according to various embodiments.

FIG. 2 is an exploded isometric view of components of the iso-modulator of FIG. 1, according to various embodiments.

FIG. 3A is a cross sectional view of the optical waveguide and the one or more layers of FIG. 2, according to various embodiments.

FIG. 3B is a cross sectional view of an optical waveguide on one or more layers similar to the optical waveguide and the one or more layers of FIG. 2, according to various embodiments.

FIGS. 4-5 illustrate a packaging process to form the iso-modulator of FIGS. 1-2, according to various embodiments.

FIG. 6 illustrates a flow chart of a process for forming the iso-modulator of FIGS. 1-2, according to various embodiments.

FIG. 7 schematically illustrates an example computing device and an optical device with an optical iso-modulator, according to various embodiments.

### DETAILED DESCRIPTION

Apparatuses, methods and storage medium associated with an optical iso-modulator are disclosed herein. In embodiments, an apparatus may include an optical waveguide formed on one or more layers, such as an isolation layer and a handling layer. A modulator driver may be coupled to a first side of the one or more layers. A magneto-optical (MO) die may be coupled to a second side of the one or more layers that is opposite the first side.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

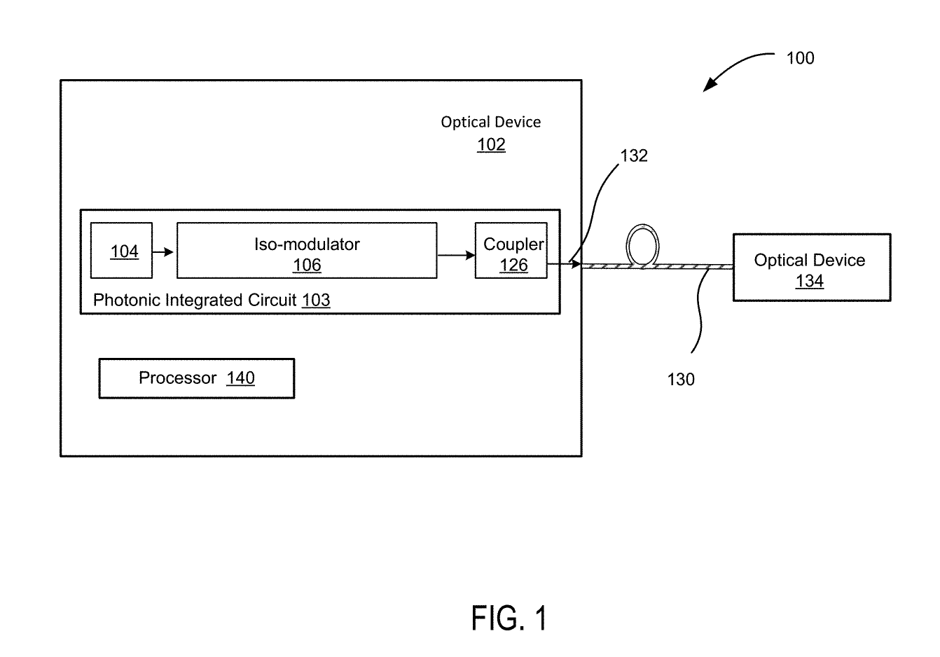

FIG. 1 is a block diagram of an optoelectronic system incorporated with a photonic integrated circuit having an iso-modulator, according to various embodiments. The optoelectronic system 100 may be used to transmit an optical signal modulated with a data signal via an optical fiber, for example, between racks in a data center, or long-distance, between data storage facilities, data centers, and the like.

The optoelectronic system 100 may include an optical device 102 having one or more PICs (photonic integrated circuits) 103 with one or more on-chip light sources (e.g., laser devices) 104 to provide a light signal (e.g., constant light intensity signal). Iso-modulator 106 may be a hybrid isolator co-functioning as a modulator. Iso-modulator 106 may be to modulate input light according to a data signal to be transmitted, and may also suppress reflections back to the light sources 104. The iso-modulator 106 may have a smaller form factor than some known PICs that include an optical isolator component between a laser component and an optical modulator component.

In various embodiments, the light source 104 may be a hybrid laser that emits light at a wavelength of approximately 1310 nanometers (nm). In some embodiments, the light source 104 may emit light at a different wavelength such as 1550 nm, for example. An optical coupler 126 may be a component of or coupled with the PIC 103. The optical coupler 126 may provide an interface to an optical communication channel (e.g., optical fiber cable or other configuration that may include coupling optics followed by fiber) 130 and may be configured to transfer an optical signal 132 to the optical communication channel 130 to be received by another optical device 134. In various embodiments, the optical device 102 may include a processor 140 that may be coupled with one or more components of the PIC 103. In some embodiments, the processor 140 may be coupled with the iso-modulator 106. In embodiments, the iso-modulator 106 may modulate a light signal from the light source 104 for transmission over the optical communication channel 130 based at least in part on a signal from the processor 140. In some embodiments, the processor 140 may include one or more modules to generate control signals for the light source 104 and/or the iso-modulator 106. The PIC 103 may include other photonic components such as splitters, couplers, filters, detectors, phase shifters, polarization rotators, multiplexers, and/or other passive or active optical elements in various embodiments. In some embodiments, multiple light signals may be multiplexed or otherwise coupled with the optical communication channel 130.

As was mentioned, the optoelectronic system 100 may utilize a coupler 126 and a light source 104. The iso-modulator 106 may provide additional feedback tolerance, low loss, and/or a smaller form factor as compared some systems that include an optical isolator component between a laser component and an optical modulator component. The additional feedback tolerance, low loss, and/or a smaller form factor may enable various types of vertical couplers. For instance, coupler 126 may be a grating coupler and/or vertical inverted taper coupler without anti-reflection coating. The additional feedback tolerance, low loss, and/or a smaller form factor may enable various types of lasers. For instance, light source 104 may include a high power laser that may include a distributed Bragg reflector laser with a short front mirror.

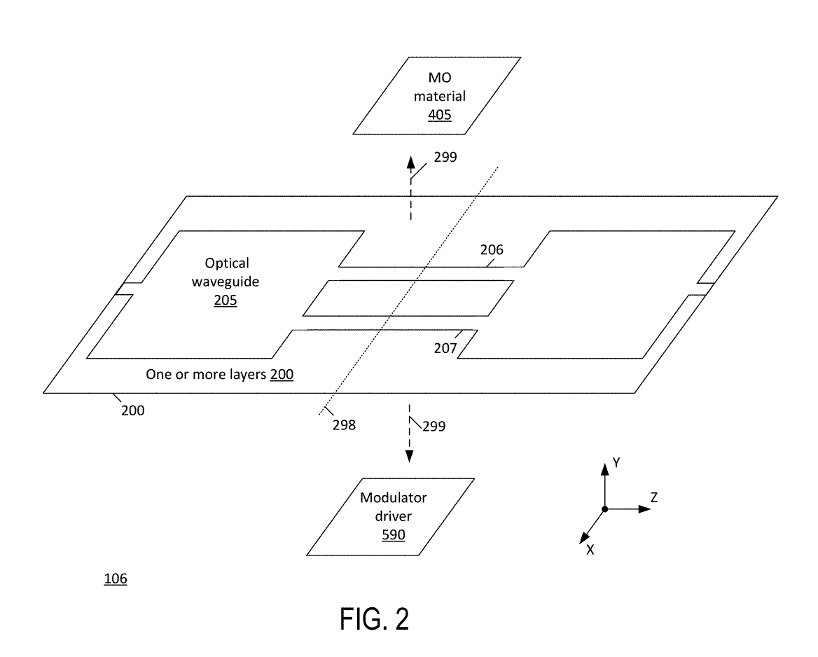

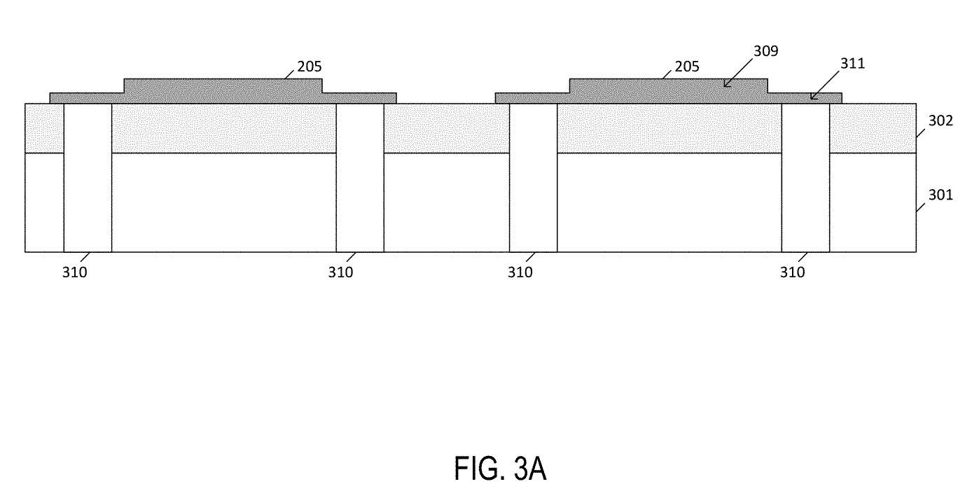

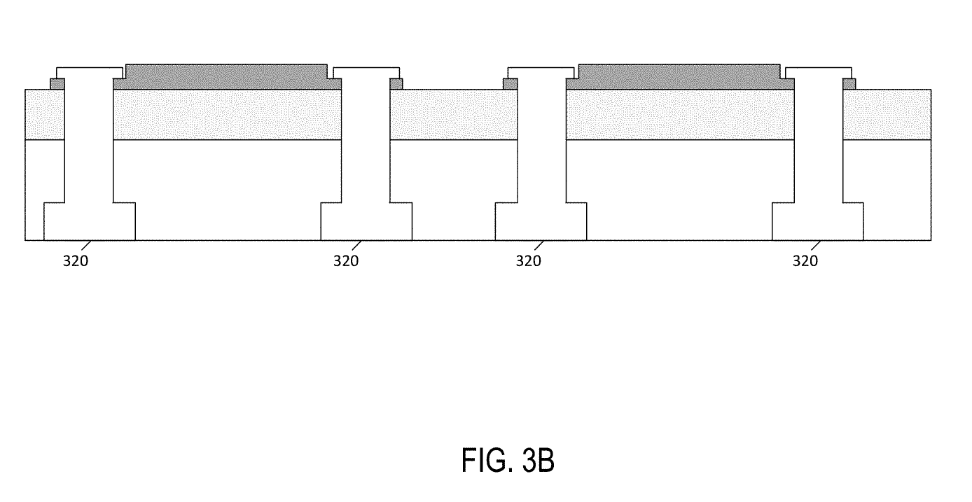

FIG. 2 is an exploded isometric view (indicated by the dashed lines 299) of components of the iso-modulator 106 of FIG. 1, according to various embodiments. The iso-modulator 106 may include an optical waveguide 205 formed on one or more layers 200, e.g., a silicon-based substrate (such as a layer of silicon dioxide on a silicon handling layer). The optical waveguide 205 on the one or more layers 200 may form a phase shifter in a Mach-Zehnder interferometer (MZI) configuration. The optical waveguide 205 and the one or more layers 200 are explained in more detail with respect to FIG. 3A, which is a cross sectional view corresponding to cutting line 298 of FIG. 2.

In embodiments, the waveguide 205 may be a three dimensional planar waveguide, e.g., a slab waveguide. The waveguide may have a width in a range of about 0.1 μm to about 2 μm. In some examples, the waveguide width may be selected based on a desired isolator and/or high speed modulation in transverse magnetic (TM) and/or transverse electric (TE) mode. In other examples, the waveguide 205 may be a one or two dimensional waveguide, such as a straight waveguide, a rib waveguide, a strip waveguide such as a rectangular core waveguide, or the like, or combinations thereof.

Referring again to FIG. 2, the dashed lines 299 indicate the exploded view of the iso-modulator 106. The iso-modulator 106 includes a modulator driver 590 coupled to a first side of the one or more layers 200 and a magneto-optical (MO) material 405 (e.g., an MO die) coupled a second side of the one or more layers 200 that is opposite the first side.

The arms 206 and 207 of the optical waveguide 205 are illustrated as having the same width (X-direction), although in other examples the arms 206 and 207, which may be referred to, respectively, as upper and lower arms, may be different widths (e.g., the arm 206 may be a greater width than the arm 207). The modulator driver 590 may be attached to a selected region of the one or more layers 200 that corresponds to a high speed modulation section of the arms 206 and 207. The modulator driver 590 may utilize any known modulator drivers, such as drivers based on CMOS (complementary metal-oxide-semiconductor) silicon.

The MO material 405 may be attached, e.g., bonded, to the second side of the one or more layers 200. The MO material 405 may include a garnet film. In various embodiments, the garnet film may be formed of a material from a rare-earth garnet family and may have a high Faraday rotation and low optical loss to produce a relatively high NRPS over a relatively short length. In some embodiments, the garnet film may include a rare-earth iron garnet (RIG) material (e.g., R₃Fe₅O₁₂), a rare-earth gallium garnet (RGG) material (e.g., R₃Ga₅O₁₂), or a rare-earth aluminum garnet (RAG) material (e.g., R₃Al₅O₁₂). In various embodiments, the garnet film may include a wide variety of elements such as Bismuth (Bi), Lutetium (Lu), Holmium (Ho), Gadolinium (Gd), Yttrium (Y), or others selected based at least in part on Faraday rotation, magnetization, or other physical properties. In some embodiments, the MO material may be grown as a single crystal on a lattice-matched substrate using liquid phase epitaxy (LPE), although other growth or deposition methods may be used (In an example, the MO material 405 may include a magneto-optic liquid phase epitaxy grown garnet film.) In various embodiments, a bismuth iron garnet (BIG) based material grown by LPE on a gadolinium gallium garnet (GGG) substrate, or a variant that may include elements such as Lu, Gd, Ga, Ho, Al, or others may be used. In some embodiments, the substrate may also have additional elements such as Europium (Eu) to more closely match a lattice constant of a desired MO film. In some embodiments, the waveguide may be a silicon waveguide and the MO garnet film may be bonded directly to a silicon surface of the waveguide such as by using a plasma-activated or other bonding process between the MO garnet film and the silicon.

In various embodiments, the iso-modulator 106 may include a cladding layer such as silicon oxide or silicon nitride to minimize reflections at the garnet interfaces. In some embodiments, the iso-modulator 106 may include polarization rotators to rotate light from the light source 104 (FIG. 1) to be in a transverse magnetic (TM) orientation while it is under the garnet film and back to a transverse electric (TE) orientation when it is no longer under the garnet film. In some embodiments, the garnet may be thinned to enable subsequent lithography. In some examples, the MO material 405 (e.g., an MO die) is bonded to the one or more layers 200, and the MO material 405 is in direct contact with the optical waveguide 205, although intervening layers may be possible.

The MO material 405 may be attached to a corresponding selected region on the second side of the one or more layers 200. A portion of the optical waveguide 205 of this corresponding selected region on the second side of the one or more layers 200 may be doped (doping will be discussed in more detail layer with respect to FIG. 3A). In some examples, the selected region may be part of a stack that includes the high modulation section of the optical waveguide 205, the MO material 405, and the modulator driver 590.

Legacy optical isolators may include optical waveguides with a plurality of arms. However, in contrast to legacy optical isolators, the iso-modulator 106 may form a magnetic field arising from interaction of the MO material 405 and a doped portion of at least one of the arms 206 or 207 (in legacy optical isolators the arms may not be doped). The magnetic field may cause light received by the iso-modulator 106 to experience non-reciprocal phase shift (NRPS). The NRPS may be associated with isolation and modulation functionality. It should be appreciated that any parameters of the optical waveguide 205 may be selected to affect a magnitude of NRPS.

The modulator driver 590 may be attached, e.g., flip-chip bonded, to the first side of the one or more layers 200. In some examples, solder bumps (not shown) may be located between the modulator driver 590 and on exposed surfaces of conductive vias (not shown) that extend through the one or more layers 200.

FIG. 3A is a cross sectional view of the optical waveguide 205 and the one or more layers 200 of FIG. 2, according to various embodiments.

In a wafer process, the isolation layer 302, e.g., a buried oxide (BOX) layer, may be formed. An example oxide may be silicon dioxide, silicon oxynitride, or silicon nitride. In some examples, a thickness of the isolation layer 302 may be on the order of microns (e.g., one micron). In some examples, the isolation layer 302 may be formed on another layer such as a handling layer 301.

The optical waveguide 205 may be formed on the isolation layer 302. The optical waveguide 205 may include doped silicon. A doping of a rib section 309 of the optical waveguide 205 may be different than a doping of the slab sections 311. The rib section 309 may protrude farther from the isolation layer 302 than the slab sections 311. The shallower slab sections 311 may be doped to operate as conductors, and doping of the rib section 309 may contribute to NRPS. The different doping may result in different dopant concentrations (e.g., higher dopant concentrations in the slab sections 311).

The conductive vias 310 (FIG. 3A) and 320 (FIG. 3B), e.g., through silicon vias (TSVs), may be etched and/or metallized before, or in some cases after, attachment of the MO material 405 (FIG. 2). For instance, referring to FIG. 3B, in some examples, via formation may be by etching and/or metallizing from a side of attachment of the MO material 405, prior to a time of MO material attachment (so that the MO material 405 remains intact to interact with the doped rib section 309). Any known process, such as a “copper nail” process, may be used. Example conductive vias 320 of FIG. 3B show an example result of formation using a “copper nail” process, prior to a time of MO material attachment.

Referring again to FIG. 3A, conductive vias 310 may be formed by, for example, etching and/or metallizing from a side that is opposite to the side of attachment of the MO material 405. Given that this etching and/or metallizing is from a side that is opposite to the side of attachment of the MO material 405, it may be possible to perform such etching and/or metallizing before, or after, a time of MO material attachment, and in either case, the MO material 405 may remain intact.

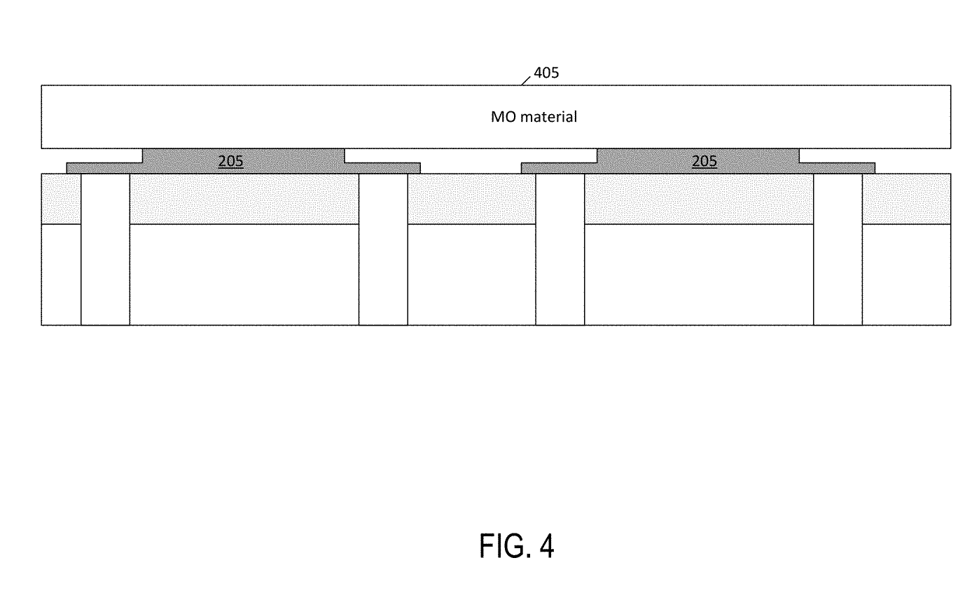

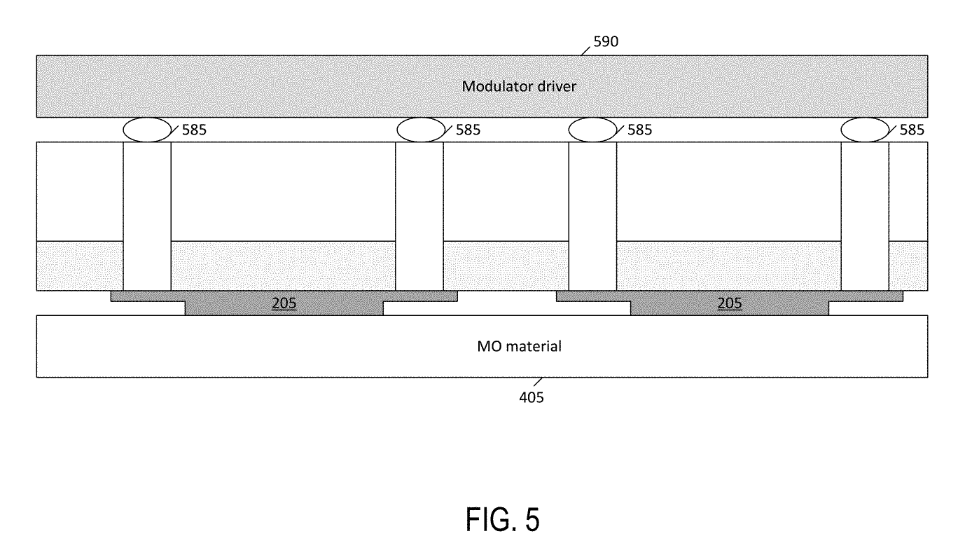

FIGS. 4-5 illustrate a packaging process to form the iso-modulator of FIGS. 1-2, according to various embodiments.

Referring to FIG. 4, the MO material 405 (e.g., a garnet die) may be attached (e.g., bonded) to a same side as the optical waveguide 205. As illustrated, in some embodiments, the MO material 405 may be in physical contact with the optical waveguide 205 (with no intervening layers).

Referring to FIG. 5, the modulator driver 590 may be attached (e.g., flip chip bonded) to the other side. In particular, solder bumps 585 may be formed on exposed conductive via surfaces to electrically connect circuity of the modulator driver 590 (e.g., CMOS silicon) to the slab sections (FIG. 3A) of the optical waveguide 205.

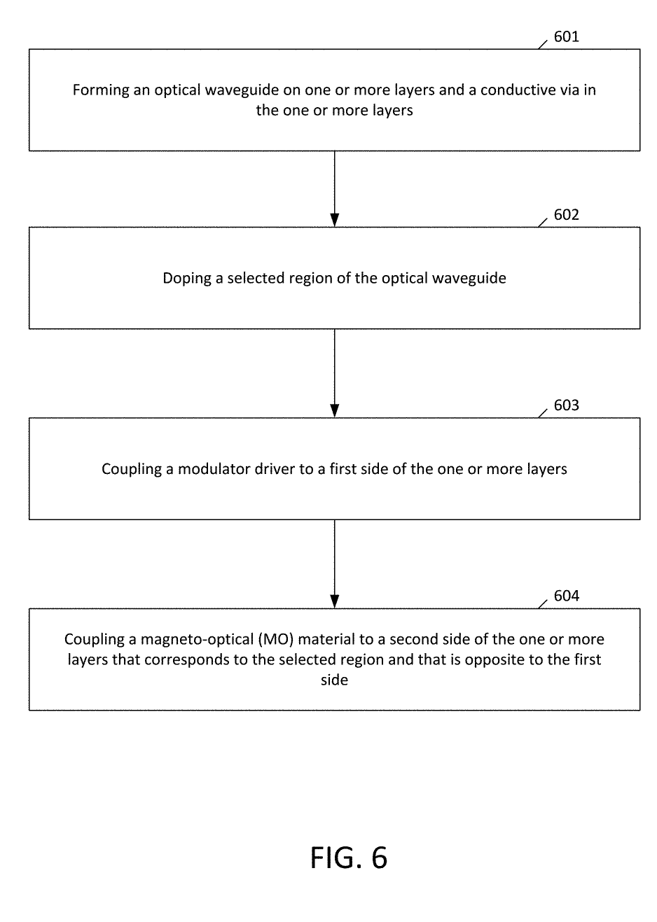

FIG. 6 illustrates a flow chart of a process for forming the iso-modulator of FIGS. 1-2, according to various embodiments.

In block 601, an optical waveguide is formed on one or more layers and a conductive via is formed in the one or more layers (for instance more than one conductive via may be formed in some examples).

In block 602, a selected region of the optical waveguide is doped. In an example, rib and slab sections of the optical waveguide are doped, and these sections may be doped differently. In block 603, a modulator driver is coupled to a first side of the one or more layer. The modulator driver may be in electrical contact with the optical waveguide by the conductive via.

In block 604, a magneto-optical (MO) material is coupled to a second side of the one or more layers that corresponds to the selected region and is opposite to the first side. In some examples, the process of coupling the MO material may be prior to the process of forming the conductive via given that the conductive vias may be etched and/or metallized from a different side than the side of attachment of the MO material.

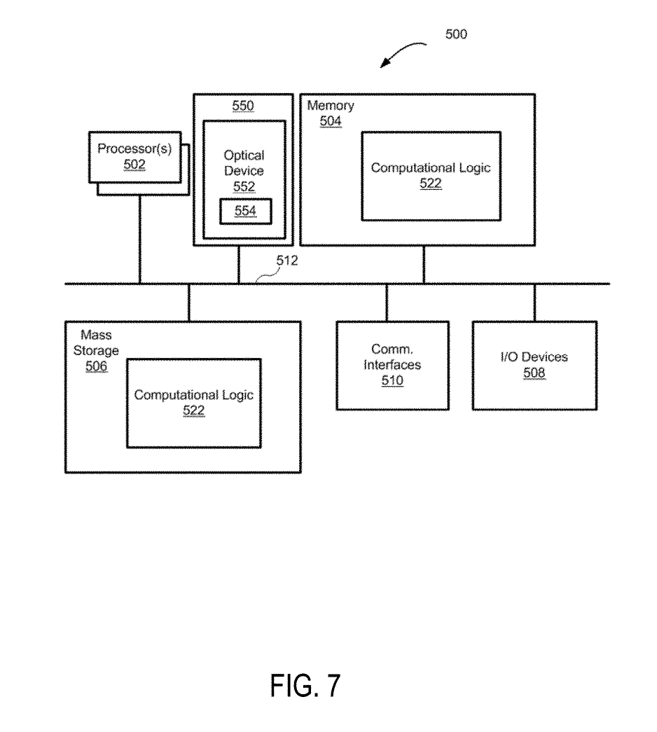

FIG. 7 schematically illustrates an example computing device 500 suitable for use with various components and processes of FIGS. 1-6, such as optoelectronic system 100 including optical device 102 with PIC (photonic integrated circuit) 103 optical iso-modulator 106 described with respect to FIG. 1, in accordance with various embodiments.

As shown, computing device 500 may include one or more processors or processor cores 502 and system memory 504. For the purpose of this application, including the claims, the terms “processor” and “processor cores” may be considered synonymous, unless the context clearly requires otherwise. The processor 502 may include any type of processors, such as a central processing unit (CPU), a microprocessor, and the like. The processor 502 may be implemented as an integrated circuit having multi-cores, e.g., a multi-core microprocessor. The computing device 500 may include mass storage devices 506 (such as diskette, hard drive, volatile memory (e.g., dynamic random-access memory (DRAM), compact disc read-only memory (CD-ROM), digital versatile disk (DVD), and so forth). In general, system memory 504 and/or mass storage devices 506 may be temporal and/or persistent storage of any type, including, but not limited to, volatile and non-volatile memory, optical, magnetic, and/or solid state mass storage, and so forth. Volatile memory may include, but is not limited to, static and/or dynamic random access memory. Non-volatile memory may include, but is not limited to, electrically erasable programmable read-only memory, phase change memory, resistive memory, and so forth.

The computing device 500 may further include input/output devices 508 (such as a display (e.g., a touchscreen display), keyboard, cursor control, remote control, gaming controller, image capture device, and so forth) and communication interfaces 510 (such as network interface cards, modems, infrared receivers, radio receivers (e.g., Bluetooth), and so forth). The computing device 500 may include an optoelectronic system 550 that may include an optical device 552 with a PIC 554 having an optical iso-modulator. In various embodiments, the optoelectronic system 550 may be similar to the optoelectronic system 100, the optical device 552 may be similar to the optical device 102 and/or the PIC 554 may be similar to the PIC 103.

The communication interfaces 510 may include communication chips (not shown) that may operate the device 500 in accordance with a Global System for Mobile Communication (GSM), General Packet Radio Service (GPRS), Universal Mobile Telecommunications System (UMTS), High Speed Packet Access (HSPA), Evolved HSPA (E-HSPA), or Long-Term Evolution (LTE) network. The communication chips may also operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chips may operate in accordance with Code Division Multiple Access (CDMA), Time Division Multiple Access (TDMA), Digital Enhanced Cordless Telecommunications (DECT), Evolution-Data Optimized (EV-DO), derivatives thereof, as well as any other wireless protocols that are designated as 3G, 4G, 5G, and beyond. The communication interfaces 510 may operate in accordance with other wireless protocols in other embodiments.

The above-described computing device 500 elements may be coupled to each other via system bus 512, which may represent one or more buses. In the case of multiple buses, they may be bridged by one or more bus bridges (not shown). Each of these elements may perform its conventional functions known in the art. In particular, system memory 504 and mass storage devices 506 may be employed to store a working copy and a permanent copy of the programming instructions, such as drivers, for the operation of various components of computer system 500, including but not limited to the operation of the optical device 102 of FIG. 1, the PIC 103 of FIG. 1, an operating system of computer system 500, and/or one or more applications, collectively referred to as computational logic 522. The various elements may be implemented by assembler instructions supported by processor(s) 502 or high-level languages that may be compiled into such instructions.

The permanent copy of the programming instructions may be placed into mass storage devices 506 in the factory or in the field through, for example, a distribution medium (not shown), such as a compact disc (CD), or through communication interface 510 (from a distribution server (not shown)). That is, one or more distribution media having an implementation of the agent program may be employed to distribute the agent and to program various computing devices.

The number, capability, and/or capacity of the elements 508, 510, 512 may vary, depending on whether computing device 500 is used as a stationary computing device, such as a set-top box or desktop computer, or a mobile computing device, such as a tablet computing device, laptop computer, game console, or smartphone. Their constitutions are otherwise known, and accordingly will not be further described.

For some embodiments, at least one of processors 502 may be packaged together with all or portions of computational logic 522 to facilitate aspects of embodiments described herein to form a System in Package (SiP) or a System on Chip (SoC).

The computing device 500 may include or otherwise be associated with an optoelectronic system that may include components and/or implement processes described with respect to FIGS. 1-6, such as optoelectronic system 100, implementing aspects of the optical device 102, including the PIC 103 or optical iso-modulator 106 as described above, and in particular the embodiments of the optical iso-modulator described in reference to FIGS. 1-6. In some embodiments, at least some components of the optoelectronic system 100 (e.g., optical device 102) may be communicatively coupled with the computing device 500 and/or be included in one or more of the computing device 500 components, such as communication interfaces 510, for example. In some embodiments, one or more components such as processor 502 may be included as a part of the optoelectronics system 100.

In various implementations, the computing device 500 may include one or more components of a data center, a laptop, a netbook, a notebook, an ultrabook, a smartphone, a tablet, a personal digital assistant (PDA), an ultra mobile PC, a mobile phone, or a digital camera. In further implementations, the computing device 500 may be any other electronic device that processes data.

### EXAMPLES

Example 1 is a photonic integrated circuit, comprising: a laser; and an iso-modulator optically coupled with the laser, wherein the iso-modulator includes an optical waveguide formed on one or more layers, the iso-modulator further including: a modulator driver coupled to a first side of the one or more layers; and a magneto-optical (MO) material coupled a second side of the one or more layers that is opposite the first side.

Example 2 includes the subject matter of example 1, and the one or more layers includes an isolation layer and a handling layer.

Example 3 includes the subject matter of any of examples 1-2, and the MO material includes an MO die, and wherein the modulator driver is bonded to solder bumps formed on the handling layer.

Example 4 includes the subject matter of any of examples 1-3, and a plurality of conductive vias that extend through the one or more layers to couple the modulator driver to the optical waveguide.

Example 5 includes the subject matter of any of examples 1-4, and the optical waveguide further comprises a rib section having a first doping concentration and a slab section having a second doping concentration that is greater than the first doping concentration.

Example 6 includes the subject matter of any of examples 1-5, and the MO material comprises a garnet film including at least one of Bismuth, Lutetium, Holmium, Gadolinium, or Yttrium.

Example 7 includes the subject matter of any of examples 1-6, and the MO material comprises a magneto-optic liquid phase epitaxy grown garnet film.

Example 8 includes the subject matter of any of examples 1-7, and the MO material further comprises a cladding coupled with the garnet film.

Example 9 includes the subject matter of any of examples 1-8, and the cladding includes silicon dioxide, silicon oxynitride, or silicon nitride.

Example 10 includes the subject matter of any of examples 1-9, and the iso-modulator is arranged in a Mach-Zehnder interferometer (MZI) configuration.

Example 11 is an iso-modulator, comprising: an optical waveguide formed on one or more layers; a modulator driver coupled to a first side of the one or more layers; and a magneto-optical (MO) die coupled to a second side of the one or more layers that is opposite to the first side.

Example 12 includes the subject matter of example 11, and at least one of the modulator driver or the MO die is bonded to the one or more layers.

Example 13 includes the subject matter of any of examples 11-12, and a plurality of through silicon vias (TSVs) that extend through the one or more layers to couple the modulator driver to the optical waveguide.

Example 14 includes the subject matter of any of examples 11-13, and ends of the TSVs are planar with a surface of an isolation layer of the one or more layers.

Example 15 includes the subject matter of any of examples 11-14, and the TSVs extend through slab sections of the optical waveguide.

Example 16 is a method, comprising: forming an optical waveguide on a silicon based substrate and a through silicon via (TSV) in the silicon based substrate; doping a selected region of the optical waveguide; coupling a modulator driver to a first side of the silicon based substrate, wherein the modulator driver and the optical waveguide in in electrical contact via the TSV; and coupling a magneto-optical (MO) material to a second side of the silicon based substrate that corresponds to the selected region and that is opposite to the first side.

Example 17 includes the subject matter of example 16, and the TSV is formed by etching the first side of the silicon based substrate.

Example 18 includes the subject matter of any of examples 16-17, and the TSV is formed after coupling the MO material to the second side of the silicon based substrate.

Example 19 includes the subject matter of any of examples 16-18, and the TSV is formed by etching the second side of the silicon based substrate.

Example 20 includes the subject matter of any of examples 16-19, and the TSV is formed prior to coupling the MO material to the second side of the silicon based substrate.

Example 21 is an optical system comprising: a processor; and an optical device coupled with the processor, wherein the optical device includes: a photonic integrated circuit comprising: a laser; and an iso-modulator optically coupled with the laser; wherein the iso-modulator includes an optical waveguide formed on one or more layers, the iso-modulator further including a modulator driver coupled to a first side of the one or more layers and a magneto-optical (MO) material coupled a second side of the one or more layers that is opposite the first side.

Example 22 includes the subject matter of example 21, and an optical coupler to transfer an optical signal of the iso-modulator to an optical communication channel, wherein the optical coupler is at least one of a grating coupler or a vertical inverted taper coupler without anti-reflection coating.

Example 23 includes the subject matter of any of examples 21-22, and the laser includes a distributed Bragg reflector laser with a short front mirror.

Example 24 includes the subject matter of any of examples 21-23, and a plurality of conductive vias that extend through the one or more layers to couple the modulator driver to the optical waveguide.

Example 25 includes the subject matter of any of examples 21-24, and the optical waveguide further comprises a rib section having a first doping concentration and a slab section having a second doping concentration that is greater than the first doping concentration.

What is claimed is:

1. A photonic integrated circuit, comprising:
a laser; and
an iso-modulator optically coupled with the laser, wherein the iso-modulator includes an optical waveguide formed on one or more layers, the iso-modulator further including:
a modulator driver coupled to a first side of the one or more layers; and
a magneto-optical (MO) material coupled a second side of the one or more layers that is opposite the first side.

2. The photonic integrated circuit of claim 1, wherein the one or more layers includes an isolation layer and a handling layer.

3. The photonic integrated circuit of claim 2, wherein the MO material includes an MO die, and wherein the modulator driver is bonded to solder bumps formed on the handling layer.

4. The photonic integrated circuit of claim 1, further comprising a plurality of conductive vias that extend through the one or more layers to couple the modulator driver to the optical waveguide.

5. The photonic integrated circuit of claim 1, wherein the optical waveguide further comprises a rib section having a first doping concentration and a slab section having a second doping concentration that is greater than the first doping concentration.

6. The photonic integrated circuit of claim 1, wherein the MO material comprises a garnet film including at least one of Bismuth, Lutetium, Holmium, Gadolinium, or Yttrium.

7. The photonic integrated circuit of claim 1, wherein the MO material comprises a magneto-optic liquid phase epitaxy grown garnet film.

8. The photonic integrated circuit of claim 6, wherein the MO material further comprises a cladding coupled with the garnet film.

9. The photonic integrated circuit of claim 7, wherein the cladding includes silicon dioxide, silicon oxynitride, or silicon nitride.

10. The photonic integrated circuit of claim 1, wherein the iso-modulator is arranged in a Mach-Zehnder interferometer (MZI) configuration.

11. An iso-modulator, comprising:
an optical waveguide formed on one or more layers;
a modulator driver coupled to a first side of the one or more layers; and
a magneto-optical (MO) die coupled to a second side of the one or more layers that is opposite to the first side.

12. The iso-modulator of claim 11, wherein at least one of the modulator driver or the MO die is bonded to the one or more layers.

13. The iso-modulator of claim 11, further comprising a plurality of through silicon vias (TSVs) that extend through the one or more layers to couple the modulator driver to the optical waveguide.

14. The iso-modulator of claim 13, wherein ends of the TSVs are planar with a surface of an isolation layer of the one or more layers.

15. The iso-modulator of claim 13, wherein the TSVs extend through slab sections of the optical waveguide.

16. A method, comprising:
forming an optical waveguide on a silicon based substrate and a through silicon via (TSV) in the silicon based substrate;
doping a selected region of the optical waveguide;
coupling a modulator driver to a first side of the silicon based substrate, wherein the modulator driver and the optical waveguide in in electrical contact via the TSV; and
coupling a magneto-optical (MO) material to a second side of the silicon based substrate that corresponds to the selected region and that is opposite to the first side.

17. The method of claim 16, wherein the TSV is formed by etching the first side of the silicon based substrate.

18. The method of claim 17, wherein the TSV is formed after coupling the MO material to the second side of the silicon based substrate.

19. The method of claim 16, wherein the TSV is formed by etching the second side of the silicon based substrate.

20. The method of claim 19, wherein the TSV is formed prior to coupling the MO material to the second side of the silicon based substrate.

21. An optical system, comprising:
a processor; and
an optical device coupled with the processor, wherein the optical device includes:
a photonic integrated circuit comprising:
a laser; and
an iso-modulator optically coupled with the laser;
wherein the iso-modulator includes an optical waveguide formed on one or more layers, the iso-modulator further including a modulator driver coupled to a first side of the one or more layers and a magneto-optical (MO) material coupled a second side of the one or more layers that is opposite the first side.

22. The optical system of claim 21, further comprising an optical coupler to transfer an optical signal of the iso-modulator to an optical communication channel;
wherein the optical coupler is at least one of a grating coupler or a vertical inverted taper coupler without anti-reflection coating.

23. The optical system of claim 21, wherein the laser includes a distributed Bragg reflector laser with a short front mirror.

24. The optical system of claim 21, further comprising a plurality of conductive vias that extend through the one or more layers to couple the modulator driver to the optical waveguide.

25. The optical system of claim 21, wherein the optical waveguide further comprises a rib section having a first doping concentration and a slab section having a second doping concentration that is greater than the first doping concentration.
